(19) United States
(12) Patent Application Publication
(10) Pub. No.: US 2025/0238260 A1
(43) Pub. Date: Jul. 24, 2025

(54) METHODS AND SYSTEMS FOR HANDLING ORDERED AND UNORDERED JOBS WITH PRIORITY AND FAIRNESS

(71) Applicant: Shopify Inc., Ottawa (CA)

(72) Inventors: Robert Cardy, Kitchener (CA); Matthew Bruce, St Pauls (CA); Alexander Jozef Hubertus Verdonschot, Ottawa (CA)

(21) Appl. No.: 18/415,907

(22) Filed: Jan. 18, 2024

(51) Int. Cl. G06F 9/48

(52) U.S. Cl. CPC G06F 9/4881

(57) ABSTRACT

A method at a computing device, the method including obtaining, from a global work queue, a marker containing an identifier for an ordered job queue and determining whether the ordered job queue is blocked. The method further including selectively processing the marker based on whether the ordered job queue is blocked. When the ordered job queue is blocked, the selective processing the marker including placing the marker back on the global work queue; and obtaining from the global work queue another job. When the ordered job queue is not blocked, the selective processing the marker including blocking the ordered job queue; obtaining a job from the ordered job queue; processing the job; and upon completing the processing of the job, unblocking the ordered job queue.

### FIELD OF THE DISCLOSURE

The present disclosure relates to job queues in computing systems, and in particular relates to job queues where some jobs need to be completed in a particular order.

### BACKGROUND

A large, distributed system may add jobs from a plurality of parallel processes to a global job queue. At the same time, a set of workers, such as worker threads or worker pods, may perform jobs from the job queue in parallel with each other.

### SUMMARY

A problem with a global queue is that some jobs may need to be performed in a particular order. For example, JobA may need to be completed before JobB is started. However, with a global job queue, if both JobA and JobB are put on the queue, there is no guarantee that JobA will be finished before JobB starts.

One solution to this is to create separate queues for ordered workflows. Thus, JobA and JobB would be put on the separate queue. However, this leads to a lack of fairness interleaving such ordered jobs with regular jobs. For example, the ordered jobs may be assigned proportionally more resources, leading to longer delays for regular jobs.

In other cases, a single worker may be dedicated to all queued jobs. This guarantees that ordered jobs are performed in order, but does not scale to accommodate a large, distributed system.

Therefore, in accordance with embodiments of the present disclosure, a main (global) “work” queue may be created. As used herein, work could mean jobs that need to be performed by workers, but could also mean markers that would lead a worker to another queue having ordered jobs therein, as described below.

Within the global work queue, a marker may be placed to indicate that the worker should go to another queue to perform an ordered job. In particular, if a task has three ordered jobs, then a separate queue for that task could be created, where the three ordered jobs are placed on the queue in order. Three markers could then be placed on the global work queue, indicating three ordered jobs need to be performed.

A worker could go to the global work queue and fetch work from the global work queue. If the work is a job, the worker could perform the job.

If the work is a marker, the worker could go to a queue based on identifiers in the marker. The worker could then make a determination whether the ordered job queue is blocked or ready. In particular, an ordered job queue may be blocked by a concurrency control constraint such as a semaphore, key, or other lock, when one of the jobs on the queue is being performed.

Thus, if the ordered job queue is ready, the worker may get the next job, and block the queue from other work. Once the job is completed, the worker could then unblock the queue.

If the ordered job queue is blocked, then the worker could put the marker back onto the global work queue and retrieve the next work item. In this way, the system is not delayed waiting for jobs to be completed, but still is able to interleave ordered and unordered jobs. As will be appreciated by those in the art, the next marker does not equate to a specific job on the ordered job queue, but rather signals to get the next job from the ordered job queue.

Thus, “marker jobs” as stored in the global queue are fungible. This enables the ordered job queue to efficiently enforce a blocking semaphore to ensure the previous job completes before starting the next job. The worker thread that takes the job and finds the queue blocked simply places that marker back on the end of the global work queue and takes the next job globally. This enables the ordered job queue to block until job completion while not blocking the global work queue.

The above may be expanded to have a plurality of global work queues. For example, a “high priority”, “medium priority”, and “low priority” global queue could exist in some situations. Markers for individual ordered job queues may be placed on any of the global queues in this case.

Therefore, in one aspect, a method at a computing device may be provided. The method may include obtaining, from a global work queue, a marker containing an identifier for an ordered job queue and determining whether the ordered job queue is blocked. The method may further include selectively processing the marker based on whether the ordered job queue is blocked. When the ordered job queue is blocked, the selectively processing the marker may includes placing the marker back on the global work queue and obtaining from the global work queue another job. When the ordered job queue is not blocked, the selectively processing the marker may include blocking the ordered job queue; obtaining a job from the ordered job queue; processing the job; and upon completing the processing of the job, unblocking the ordered job queue.

In some embodiments, the number of markers placed on the global work queue pointing to the ordered job queue may correspond with a number of jobs placed on the ordered job queue.

In some embodiments, the identifier may correspond to a key generated by concatenating multiple business logic level identifiers.

In some embodiments, the placing the marker back on the global work queue may comprise dequeuing the marker and adding the marker to an end of the global work queue.

In some embodiments, the determining whether the ordered job queue is blocked may comprise checking a concurrency control construct at the ordered job queue.

In some embodiments, the concurrency control construct may include at least one of a key, a semaphore, a mutex, and a lock.

In some embodiments, the global work queue may be one of a plurality of global work queues.

In some embodiments, the global work queue may contain markers with identifiers corresponding to a plurality of ordered job queues, each of the plurality of ordered job queues having a different identifier.

In some embodiments, the method may further comprise setting a Time to Live (TTL) when blocking the ordered job queue, wherein when TTL is exceeded the job is placed back on the ordered job queue and the marker is placed back on the global work queue.

In a further aspect, a computer device comprising a processor and memory may be provided. The computer device may be configured to obtain, from a global work queue, a marker containing an identifier for an ordered job queue and determine whether the ordered job queue is blocked. When the ordered job queue is blocked, the computer device may process the marker by placing the marker back on the global work queue and obtaining from the global work queue another job. When the ordered job queue is not blocked, the computer device may process the marker by blocking the ordered job queue; obtaining a job from the ordered job queue; processing the job; and upon completing the processing of the job, unblocking the ordered job queue.

In some embodiments, the number of markers placed on the global work queue pointing to the ordered job queue may correspond with a number of jobs placed on the ordered job queue.

In some embodiments, the identifier may correspond to a key generated by concatenating multiple business logic level identifiers.

In some embodiments, the computer device may place the marker back on the global work queue by dequeuing the marker and adding the marker to an end of the global work queue.

In some embodiments, the computer device may be configured to determine whether the ordered job queue is blocked by checking a concurrency control construct at the ordered job queue.

In some embodiments, the concurrency control construct may include at least one of a key, a semaphore, a mutex, and a lock.

In some embodiments, the global work queue may be one of a plurality of global work queues.

In some embodiments, the global work queue may contain markers with identifiers corresponding to a plurality of ordered job queues, each of the plurality of ordered job queues having a different identifier.

In some embodiments, the computer device may further be configured to set a Time to Live (TTL) when blocking the ordered job queue, wherein when TTL is exceeded the job is placed back on the ordered job queue and the marker is placed back on the global work queue.

In a further aspect, a computer readable medium for storing instruction code may be provided. The instruction code, when executed by a processor of a computing device, may cause the computing device to obtain, from a global work queue, a marker containing an identifier for an ordered job queue and determine whether the ordered job queue is blocked. When the ordered job queue is blocked: the instruction code may cause the computing device to process the marker by placing the marker back on the global work queue and obtaining from the global work queue another job. When the ordered job queue is not blocked, the instruction code may cause the computing device to process the marker by blocking the ordered job queue; obtaining a job from the ordered job queue; processing the job; and upon completing the processing of the job, unblocking the ordered job queue.

In some embodiments, the number of markers placed on the global work queue pointing to the ordered job queue may correspond with a number of jobs placed on the ordered job queue.

### BRIEF DESCRIPTION OF THE DRAWINGS

The present disclosure will be better understood with reference to the drawings, in which:

FIG. 1 is a block diagram showing a job queue having a subset of ordered jobs thereon.

FIG. 2 is a block diagram showing a job queue for unordered jobs and a separate job queue for ordered jobs.

FIG. 3 is a block diagram showing a work queue having both markers and unordered jobs, along with a separate ordered job queue to which the marker may point.

FIG. 4 is a process diagram showing a process for executing both ordered and unordered jobs with priority and fairness.

FIG. 5 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, methods and systems for processing jobs in a computing environment are provided. In some cases, the computing environment may be a large, distributed environment in which a plurality of parallel jobs may exists, which may be performed by a plurality of workers.

However, in some cases jobs may need to be performed in a particular order. For example, a precondition of a second job may be information or states that may be achieved by performing a first job, and thus the second job should not be performed until the first job is completed.

### Waiting for or Rearranging Ordered Tasks

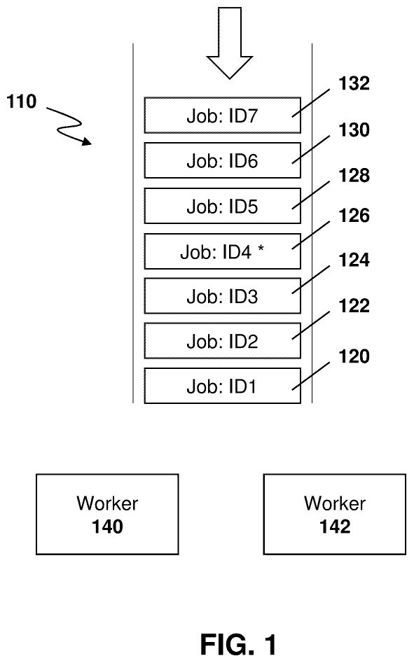

A first way to deal with ordered jobs on a global job queue would be to pause execution of a job until the predecessor job has been completed. Thus, reference is made to FIG. 1.

In the embodiment of FIG. 1, a global queue 110 may be part of a computing system. Global queue 110 may exist for the entire system, or for various parts of the system. As used herein, a global queue may be defined as a queue which services one or more entities within the system.

Queue 110 may include a plurality of jobs, shown as jobs 120, 122, 124, 126, 128, 130 and 132 in the example of FIG. 1. Further, in the example of FIG. 1, queue 110 is a first in, first out queue in which jobs may be placed on to the queue as they arise within the system. Thus, jobs 120-132 may be processed on a first-come, first-served basis.

Further, each job 120-132 can be a task, action or other function that a worker such as worker 140 or worker 142, can perform. This may be referred to as servicing the queue in some cases.

In some cases, jobs 120-132 may include various data structures and may include key values which may be toggled or changed by the workers 140 and 142. Thus, for example, if worker 140 takes job 120 from global queue 110, rather than removing the job from the queue, a key within job 120 may be changed to indicate that the job is being worked on. This allows for the job to survive if worker 140 for some reason unexpectedly ends among other benefits. In this case, the job may be removed from queue 110 once it has been successfully processed.

Further, jobs 120-132 may have a predecessor job that must be completed before such next job is processed. This is, for example, shown with an asterisk in job 126 in the example of FIG. 1. Job 126 may, for example, indicate that job 124 must be completed before it is worked on.

Workers 140 and 142 may be any processing function that exists within a computing system that is capable of working on jobs 120-132. Examples can include use of processor cores or threads, for example on a central processing unit (CPU), graphical processing units (GPUs), programable gate arrays (PGAs), field programable gate arrays (FPGAs), among other options.

In practice, once a worker 140 is finished with the previous job it may go to the global queue 110 and take the next job which, in the example of FIG. 1, is job 120. Similarly, worker 142 may finish with its previous job and take a job 122 from global queue 110.

This may continue until a worker gets to job 126, which requires a predecessor job to be completed prior to working on the job. The worker would then have several choices. A first would be to delay processing of job 126 until job 124 is completed. However, such solution is inefficient as the worker is idle while waiting for job completion.

A second option would be to put job 126 at the end of queue 110 and proceed to the next job. However, this may create several issues.

By moving jobs to the end of the queue 110, this may cause delays in the processing of such ordered jobs, and therefore unfairness in the system.

Further, if there are multiple jobs that need to be completed in order, then moving job 126 to the end of the queue may cause a problem with the next ordered task. For example, if a task execution order requires job 124 to be completed before job 126, which must be completed before job 130, by moving job 126 to the end of the queue, job 130 now appears earlier on the queue than job 126.

Job 130 would therefore need to be moved to the end of the queue when a worker reaches it.

This again would cause delays in the processing of such ordered jobs, and therefore unfairness in the system. It further causes significant overhead with regard to noting which jobs must be completed before other jobs, tracking job IDs, among other factors.

In some cases, to overcome the above, only a single worker is assigned to a single queue. While this ensures that jobs are completed in order and removes the overhead required to track job order, such solution does not scale well. For example, a system may have processing requirements that spike at certain times of the day and require additional computational resources. However, a system that is built to function based on the spikes would waste resources when in a lower period of computing demand.

Conversely, if more queues and workers could be brought online on demand, the participants in the system would need a solution on how to allocate jobs to certain queues, making the system more complex.

### Separate Queue for In-Order Jobs

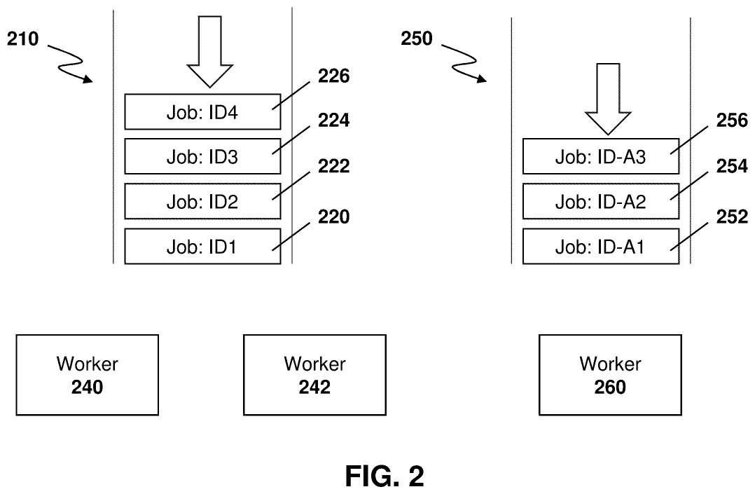

In another case, separate queues may be used for ordered jobs. Reference is now made to FIG. 2.

In the example of FIG. 2, a first queue 210 may be a global job queue for jobs that are unordered. In the example of FIG. 2, these are shown as jobs 220, 222, 224, and 226.

One or more workers, shown as workers 240 and 242 in the example of FIG. 2, may be assigned to work on jobs in queue 210.

Ordered jobs may avoid using queue 210, and may instead be placed on an ordered job queue 250. Such jobs are shown in the example of FIG. 2 as jobs 252, 254 and 256. In the example of FIG. 2, the jobs are all part of the same ordered job list (e.g. task “A”). Therefore, in some cases a separate queue 250 may be created for each group of ordered jobs. However, in other cases a plurality of groups of ordered jobs may be placed on queue 250.

A worker 260 may be assigned to queue 250.

As will be appreciated by those in the art, such system leads to unfairness. In particular, a group of ordered jobs are, in the example of FIG. 2, given a separate and dedicated worker 260. Therefore, the ordered jobs are likely to be processed more quickly than if such jobs were placed on queue 210.

Thus, such implementations include creating a separate queue for ordered jobs, which are not part of a global job queue, which leads to no fairness interleaving with regular jobs.

### Using Markers With Work Queues

In accordance with embodiments of the present disclosure, rather than a global “job” queue, a “work” queue is provided, where a work queue includes both jobs and markers. A work queue may further sometimes be referred to as a producer consumer queue.

A marker, as used herein, is a placeholder used to indicate to a worker that the job is on another queue. In particular, a marker would generally provide an “address” for the second queue, where such address could be a memory location, a pointer, a Uniform Resource Locator, among other options.

The second queue could be an ordered job queue. Thus, for example, if three jobs need to be performed in order, the three jobs may be placed on the ordered job queue in the correct order, and three markers with addresses to the ordered job queue may be placed on the global job queue.

The markers are fungible, in that they do not point to a particular job, but rather to a job queue where the next job scheduled to be processed may be fetched by a worker.

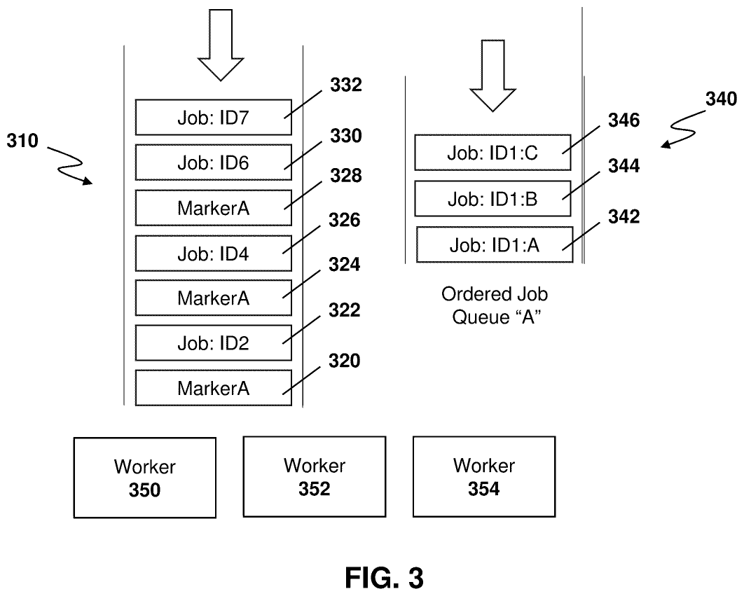

Reference is now made to FIG. 3. In the example of FIG. 3, a global work queue 310 comprises a plurality of jobs and markers. In particular, the queue may have various markers such as markers 320, 324 and 328 placed on the queue. Each of markers 320, 324 and 328 may point to an ordered job queue 340.

Markers 320, 324 and 328 are interleaved with regular jobs, shown in the example of FIG. 3 as jobs 322, 326, 330 and 332.

Ordered job queue 340 includes jobs 342, 344 and 346, which must be performed in order.

The example of FIG. 3 shows three workers, namely workers 350, 352 and 354. However, this is merely provided for illustration, and in some cases the number of workers may be higher or lower. Further, the number of workers may be dynamic, where for example more workers could be allocated to a queue when a queue grows beyond a threshold size, and where workers could be deallocated when the queue shrinks beyond some threshold size. The thresholds for allocating or deallocating workers could, in some cases, be the same and, in other cases, could be different. Other options for allocating workers would be apparent to those in the art having regard to the present disclosure.

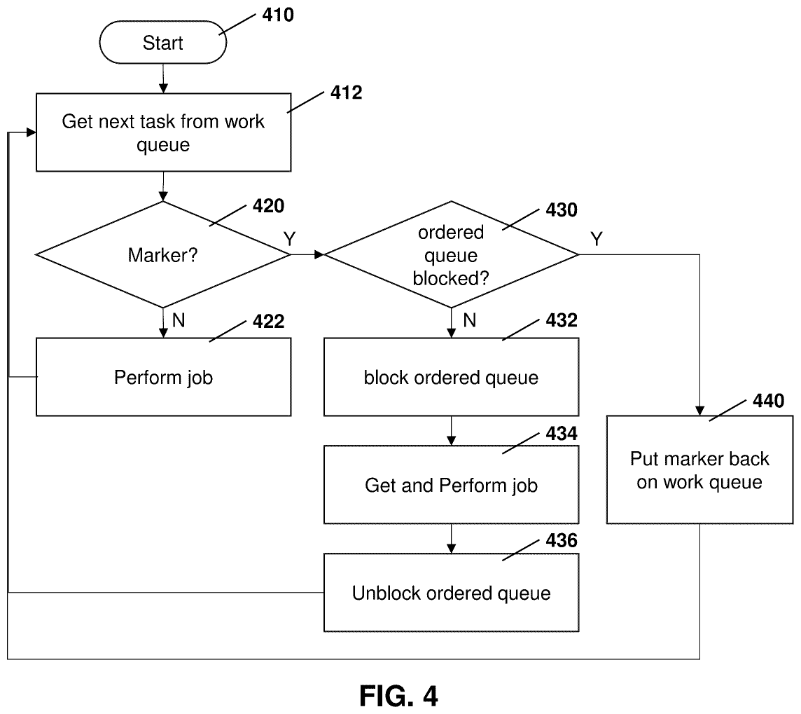

Such workers may access the work queue 310 to extract the next work item from the queue. If the next work item is a marker, the worker could then go to the ordered job queue 340 and obtain the next job if the ordered job queue is not locked. Conversely, if the item from work queue 310 is a job, the worker may perform the job. Both are described below with regard to FIG. 4.

The process of FIG. 4 starts at block 410 and proceeds to block 412 in which the worker may get the next task from the work queue. Depending on the implementation of the work queue, this getting of the next task may be a call, for example through an application program interface or a class method. The getting of the next task may be a pop or removal from the head of a queue. The getting of the next task may involve setting a marker or variable on the task indicating that the element is being processed. The getting of the next task may involve moving the job payload out of the queue and into a different key, for example in Redis, to indicate that it is in-progress. Other options for the getting of a task are possible.

From block 412, the process proceeds to block 420 in which a check is made to determine whether the task that was obtained from the work queue at block 412 is a marker. For example, the check may determine whether a marker such as marker 320 from FIG. 3 was obtained or whether a job such as job 322 was obtained.

If a marker was not obtained, and therefore a job was obtained, the worker may perform the job at block 422 and the process may proceed back to block 412 to get the next task from the work queue once the job is finished.

Conversely, if at block 420 it was found that the task obtained from the work queue is a marker, the process proceeds to block 430 in which a check may be performed on a secondary queue (i.e. an ordered job queue). Specifically, the marker obtained from the work queue at block 412 may contain an address or a pointer to the ordered job queue (such as queue 340 from FIG. 3) which will indicate where the worker should obtain its next job. As will be appreciated by those in the art, the marker merely points to the ordered job queue, and not to a particular job within the queue.

The check at block 430 may be used to determine whether the ordered job queue is blocked. Specifically, the ordered job queue may be blocked when a job within the queue is being worked on. Since the queue requires the jobs in it to be performed in a particular order, one feature of such queue may be that it can be blocked while a job is being processed. Such blocking may use any concurrency control constraint, and can take various forms such as a semaphore, key, or other lock, when one of the jobs on the queue is being performed.

Further, in some cases the queue itself is blocked, while in other cases the job at the head of the queue could be blocked, thereby blocking the queue. If it is the job that is blocked, this could be in the form of a key or constraint associated with the job that indicates that the job is being worked on. In this case, the job may not necessarily be removed from the queue until the processing for the job is finished. This could allow the job to be reinstated onto the queue if a worker fails or crashes before processing of the job is completed, for example.

Therefore, at block 430, a check is made to determine whether the ordered queue is blocked. If not, the process proceeds to block 432 in which the ordered job queue is blocked. Again, this may be implemented using any concurrency control constraint and could be either on a queue level and/or on the job at the head of the queue level.

The process may then proceed to block 434 in which the job at the head of the ordered job queue is obtained and processed. The obtaining of the job at the head of the job queue may involve changing a key or constraint at the job to indicate that it is being worked on in some cases. In other cases, the job may be popped or removed from the ordered job queue. Other options for obtaining the job from the queue are possible.

Once the worker is finished processing the job, the process proceeds from block 434 to block 436 in which the ordered job queue may be unblocked. This may, in some cases, involve removing a job from the queue. For example, if the queue is a linked list, the head pointer may be assigned to point to the next job in the queue. Other options for removing a job from the queue are possible.

From block 436 the process proceeds back to block 412 in which the worker may obtain the next task from the work queue.

If, at block 430, the ordered job queue is blocked, the process may proceed to block 440 in which the marker may be put back on to the work queue. This may be done in various ways. If the marker was removed from the work queue, for example by reassigning the head pointer to the next item in the work queue, then the marker may be placed at the tail of the work queue. This may involve assigning links to the previous tail of the work queue. Other options are possible.

In other cases, if the marker was not removed but a key on the marker was changed to indicate that the marker was being worked on, the marker may be popped or removed from the queue by reassigning the head pointer for the queue and the marker may then be put at the tail of the queue.

Other options for placing the marker at the end of the queue are possible.

From block 440 the process proceeds to block 412 in which the worker may be assigned to the next task on the work queue.

As will be appreciated by those in the art, the process of FIG. 4 allows for jobs to be performed in order while maintaining fairness in the interleaving of such ordered jobs with unordered jobs. Specifically, the markers do not point to a particular job but merely point to a queue that stores ordered jobs. In this way, the next marker for that ordered queue that is encountered by a worker will have that worker go to try to obtain the next job to be processed. If such job is not blocked, then the worker will be assigned that job. Otherwise, the marker can be placed back at the tail of the work queue to have the jobs on the ordered queue performed in order. The markers are thereby interleaved with the regular jobs and are processed in a way that leads to fairness for all parties in the computing system.

While the embodiments of FIGS. 3 and 4 have a single work queue and a single ordered job queue, in practice a plurality of queues may exist in a system. For example, each set of jobs that need to be performed in order could be assigned their own ordered job queue and the markers in the global work queue could point to a particular ordered job queue. Specifically, some markers may point to a queue at address or location “A”, while some markers on the same work queue could point to a queue at address or location “B”, etc.

In other cases, a plurality of work queues could exist in a system. For example, jobs may be classified as having different priorities and each priority may have a separate queue. Thus, a high priority, medium priority and low priority work queue may exist in some examples. Markers and jobs may be placed on any of these queues, depending for example on classification algorithms. Typically, all the markers for a particular set of ordered jobs will be placed on the same work queue. However, this is not necessary.

In other cases, the work queues may be divided by geography, or based on some classification. Thus, the present disclosure is not limited to a single work queue or a single ordered job queue.

Regardless of the number of work queues, markers stored in such queues are fungible, enabling the ordered job queues to efficiently enforce a blocking semaphore to ensure the previous job completes before starting the next job. The worker thread that takes the job and finds the queue blocked simply places that marker back on the end of the work queue from which the marker was obtained and takes the next task from that work queue. This enables the ordered job queues to block until job completion while not blocking the global work queue.

Further, in some cases, the blocking of the ordered job queue can involve setting a Time-to-Live (TTL) value to ensure that the job is processed within a certain time. This ensures that if the worker fails, the queue is not blocked forever. Rather, at TTL expiry, the job may be placed back on the ordered job queue (in practice this may simply involve resetting a key on the job as it may not be removed from the queue until processing is finished, but rather a key may be set), and putting the marker back on the work queue.

In an example implementation, the marker queue could exist as a Redis queue, and the marker could contain an identifier that corresponds to the Redis key. This key can be made from an identifier at the business logic level. For example, in one case this may include a shop name in a multi-shop webservice, a userid, among other information. In some cases, the key can be generated by concatenating multiple business logic level identifiers.

However, other implementations are possible.

In one example, the computing system may be an electronic commerce platform with a plurality of storefronts. The owners of the storefronts may manage the storefronts by, for example, adding products, changing products, removing products, changing the look of the storefront, among other tasks. For example, before posting a product on a storefront the product may need to be created in a background database and information assigned to the product. Thus, jobs may include creation of the product in the database, updating information in the database regarding the product, and posting the product on the storefront. These jobs need to be executed in order.

Further, while an electronic commerce platform is described as an example computing system, this is merely provided for illustration, and the present disclosure is not limited to such computing system. The embodiments described herein could equally be used with other computing systems.

### Computing Device

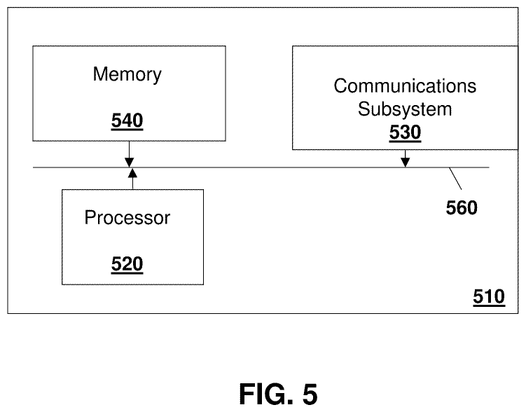

The above-discussed methods are computer-implemented methods and require a computer for their implementation/use. Such computer system could be implemented on any type of, or combination of, network elements or computing devices. For example, one simplified computing device that may perform all or parts the embodiments described herein is provided with regard to FIG. 5.

In FIG. 5, computing device 510 includes a processor 520 and a communications subsystem 530, where the processor 520 and communications subsystem 530 cooperate to perform the methods of the embodiments described herein.

The processor 520 is configured to execute programmable logic, which may be stored, along with data, on the computing device 510, and is shown in the example of FIG. 5 as memory 540. The memory 540 can be any tangible, non-transitory computer readable storage medium, such as DRAM, Flash, optical (e.g., CD, DVD, etc.), magnetic (e.g., tape), flash drive, hard drive, or other memory known in the art. In one embodiment, processor 520 may also be implemented entirely in hardware and not require any stored program to execute logic functions. Memory 540 can store instruction code, which, when executed by processor 520 cause the computing device 510 to perform the embodiments of the present disclosure.

Alternatively, or in addition to the memory 540, the computing device 510 may access data or programmable logic from an external storage medium, for example through the communications subsystem 530.

The communications subsystem 530 allows the computing device 510 to communicate with other devices or network elements. In some embodiments, communications subsystem 530 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a Global Positioning System (GPS) receiver, a satellite transceiver, an IrDA transceiver, among others. As will be appreciated by those in the art, the design of the communications subsystem 530 will depend on the type of communications that the transaction device is expected to participate in.

Communications between the various elements of the computing device 510 may be through an internal bus 560 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer method comprising:
obtaining, from a global work queue, a marker containing an identifier for an ordered job queue;
determining whether the ordered job queue is blocked;
and selectively processing the marker based on whether the ordered job queue is blocked, wherein:
when the ordered job queue is blocked, selectively processing the marker includes:
placing the marker back on the global work queue; and
obtaining from the global work queue another job; and
when the ordered job queue is not blocked, selectively processing the marker includes:
blocking the ordered job queue;
obtaining a job from the ordered job queue;
processing the job; and
upon completing the processing of the job, unblocking the ordered job queue.

2. The method of claim 1, wherein a number of markers placed on the global work queue pointing to the ordered job queue corresponds with a number of jobs placed on the ordered job queue.

3. The method of claim 1, wherein the identifier corresponds to a key generated by concatenating multiple business logic level identifiers.

4. The method of claim 1, wherein the placing the marker back on the global work queue comprises dequeuing the marker and adding the marker to an end of the global work queue.

5. The method of claim 1, wherein the determining whether the ordered job queue is blocked comprises checking a concurrency control construct at the ordered job queue.

6. The method of claim 5, wherein the concurrency control construct includes at least one of a key, a semaphore, a mutex, and a lock.

7. The method of claim 1, wherein the global work queue is one of a plurality of global work queues.

8. The method of claim 1, wherein the global work queue contains markers with identifiers corresponding to a plurality of ordered job queues, each of the plurality of ordered job queues having a different identifier.

9. The method of claim 1, further comprising setting a Time to Live (TTL) when blocking the ordered job queue, wherein when TTL is exceeded the job is placed back on the ordered job queue and the marker is placed back on the global work queue.

10. A computer device comprising:
a processor; and
memory,
wherein the computing device is configured to:
obtain, from a global work queue, a marker containing an identifier for an ordered job queue;
determine whether the ordered job queue is blocked;
when the ordered job queue is blocked: process the marker by:
placing the marker back on the global work queue; and
obtaining from the global work queue another job; and
when the ordered job queue is not blocked, process the marker by:
blocking the ordered job queue;
obtaining a job from the ordered job queue;
processing the job; and
upon completing the processing of the job, unblocking the ordered job queue.

11. The computer device of claim 10, wherein the number of markers placed on the global work queue pointing to the ordered job queue corresponds with a number of jobs placed on the ordered job queue.

12. The computer device of claim 10, wherein the identifier corresponds to a key generated by concatenating multiple business logic level identifiers.

13. The computer device of claim 10, wherein the computer device is configured to place the marker back on the global work queue by dequeuing the marker and adding the marker to an end of the global work queue.

14. The computer device of claim 10, wherein the computer device is configured to determine whether the ordered job queue is blocked by checking a concurrency control construct at the ordered job queue.

15. The computer device of claim 14, wherein the concurrency control construct includes at least one of a key, a semaphore, a mutex, and a lock.

16. The computer device of claim 10, wherein the global work queue is one of a plurality of global work queues.

17. The computer device of claim 10, wherein the global work queue contains markers with identifiers corresponding to a plurality of ordered job queues, each of the plurality of ordered job queues having a different identifier.

18. The computer device of claim 10, wherein the computer device is further configured to set a Time to Live (TTL) when blocking the ordered job queue, wherein when TTL is exceeded the job is placed back on the ordered job queue and the marker is placed back on the global work queue.

19. A computer readable medium for storing instruction code, which, when executed by a processor of a computing device cause the computing device to:
obtain, from a global work queue, a marker containing an identifier for an ordered job queue;
determine whether the ordered job queue is blocked;
when the ordered job queue is blocked: process the marker by:
placing the marker back on the global work queue; and
obtaining from the global work queue another job; and
when the ordered job queue is not blocked, process the marker by:
blocking the ordered job queue;
obtaining a job from the ordered job queue;
processing the job; and
upon completing the processing of the job, unblocking the ordered job queue.

20. The computer readable medium of claim 19, wherein the number of markers placed on the global work queue pointing to the ordered job queue corresponds with a number of jobs placed on the ordered job queue.
